(19) United States
(12) Patent Application Publication
(10) Pub. No.: US 2013/0137137 A1
(43) Pub. Date: May 30, 2013

(54) AUTOMATED SYSTEM TO CREATE A CELL SMEAR

(71) Applicants: Michael D. Brody, Premont, CA (US); Jonathan D. Halderman, Santa Clara, CA (US); Bhairavi Parikh, Palo Alto, CA (US); James Stone, Saratoga, CA (US)

(72) Inventors: Michael D. Brody, Premont, CA (US); Jonathan D. Halderman, Santa Clara, CA (US); Bhairavi Parikh, Palo Alto, CA (US); James Stone, Saratoga, CA (US)

(21) Appl. No.: 13/643,614

(22) PCT Filed: May 9, 2011
(86) PCT No.: PCT/US11/35761

§ 371 Date: Feb. 11, 2013

Related U.S. Application Data
(60) Provisional application No. 61/332,618, filed on May 7, 2010.

(51) Int. Cl. G01N 1/28

(52) U.S. Cl. CPC G01N 1/2813
USPC 435/40.51; 435/283.1; 435/288.7; 435/286.3

(57) ABSTRACT

A method of creating a layer of cells on a surface. In some embodiments, the method includes the steps of engaging a smear tool against the surface with an engagement force; flexing a portion of the smear tool to change an orientation of the smear tool with respect to the surface; moving the smear tool along the surface through a sample comprising cells suspended in a liquid; and adhering the sample to the surface to thereby create a layer of cells. Another method according to the invention creates a layer of cells on a surface by mixing the sample prior to and/or during the smear. The invention also includes systems for implementing the methods.

### CROSS REFERENCE TO RELATED APPLICATIONS

This application claims the benefit under 35 U.S.C. 119 of U.S. application No. 61/332,618, filed May 7, 2010, the disclosure of which is incorporated herein by reference.

### INCORPORATION BY REFERENCE

All publications and patent applications mentioned in this specification are herein incorporated by reference to the same extent as if each individual publication or patent application was specifically and individually indicated to be incorporated by reference.

### BACKGROUND OF THE INVENTION

The study of blood and its normal and diseased states dates back to blood letting in Ancient Egypt but the field really gained traction in 1624 when Anthony van Leeuwenhoek built the first microscope that was able to image blood cells. In 1770 William Hewson provided the first description of leukocytes (white blood cells) for which he has been dubbed the father of hematology. The field of hematology therefore has a very long history and techniques that have served well over the years have remained essentially unchanged until a significant need arises to require change. One such technique is the creation of a blood smear for microscopic review. Diagnostic techniques utilize a relatively small number of cells due to the fact that most slides are reviewed by humans. Therefore, the fact that only a small portion of the smear (between 2 mm and 4 mm of the overall smear length) was available for review was not a significant hindrance to diagnosis.

As Automated Digital Microscopy (ADM) becomes more widely used, the ability to interrogate a larger number of cells than is possible by human inspection drives up the accuracy of diagnosis. For very effective ADM, it is necessary to create a monolayer of the cells to be examined. This monolayer must have sufficiently high packing of objects such that the ADM is cost and time effective but must not cause the objects to be so tightly packed that they clump or lie on top of each other

The manual process of creating a simple blood smear includes the following. Place a drop of blood on a microscope slide (“substrate”) and use a second microscope slide to create a meniscus that is then moved (pulled) along the length of the first microscope slide. The cells are spread across the first slide. The process is quick and as has been noted it provides sufficiently many cells for manual review to produce a diagnosis. Some systems automate this process to create machine generated smears (e.g., Sysmex, Beckman Coulter). However these processes do not yield the high packing, monolayer of cells of uniform high quality needed for performing Automated Digital Microscopy.

Both fetal cells and tumor cells have been found circulating in the blood. This opens the possibility of performing simple blood tests to detect fetal genetic status and disease state. However, the numbers of cells circulating are very low compared with the number of non-fetal or non-tumorigenic cells. Improved methods are needed to identify the rare fetal and tumor cells from the blood. One method is to enrich a blood sample for the cells of interest and mark or identify the cells of interest using specific DNA or cell stains or to analyze RNAs or proteins using, for example, in situ hybridization or immunohistochemistry. The cells of interest must be then be separated and analyzed separately from other cells. One such method to separate the cells using an automated cell smear system, methods, and apparatus is described herein and in U.S. patent application 13/046,543, filed Mar. 11, 2011, the disclosure of which is incorporated in its entirety.

### SUMMARY OF THE INVENTION

One aspect of the invention provides a method of creating a layer of cells on a surface. In some embodiments, the method includes the steps of engaging a smear tool against the surface with an engagement force; flexing a portion of the smear tool to change an orientation of the smear tool with respect to the surface; moving the smear tool along the surface through a sample comprising cells suspended in a liquid; and adhering the sample to the surface to thereby create a layer of cells. In some embodiments, the smear tool has a forward edge, and the engaging step includes the step of changing a relative angle between the forward edge and the surface and/or changing a distance between the forward edge and the surface during the moving step.

Prior to the moving step in some embodiments, the sample is dispensed onto the surface in a sample pattern that extends at least three times further in a first direction than in a direction perpendicular to the first direction. Examples of such sample patterns include two separate sample portions and a continuous shape.

Some embodiments include the optional step of monitoring a parameter of the sample, such as by measuring light transmittance through at least a portion of the sample or layer of cells. In such embodiments the moving step may include the step of controlling movement of the smear tool using closed loop feedback based on the parameter.

In some embodiments, prior to the moving step, the method includes the steps of dispensing the sample onto the surface and thereafter mixing at least a portion of the sample. The method may also include the step of mixing at least a portion of the sample prior to the moving step. The smear tool may be engaged with the sample prior to the mixing step such as by, e.g., moving the smear tool in a first direction along the surface to engage the smear tool with the sample, with the mixing step including the step of moving the smear tool in a direction other than the first direction after engaging the smear tool with the sample. Examples of mixing include oscillating the smear tool (e.g., at a frequency between about 1 Hz to about 100 Hz); moving the smear tool in at least two directions with respect to the surface; and changing a distance between the smear tool and the surface.

Some embodiments include the step of mixing at least a portion of the sample during the moving step. Once again, examples of such mixing include oscillating the smear tool (e.g., at a frequency between about 1 Hz to about 100 Hz); moving the smear tool in at least two directions with respect to the surface; and changing a distance between the smear tool and the surface.

In some embodiments, the moving step includes the step of varying a relative speed between the smear tool and the surface. The method may also include the step of accelerating drying of the monolayer after the adhering step.

The smear can have various shapes and sizes. In some embodiments, the adhering step includes the step of adhering the sample in a smear at least about 50 mm long. The smear may have an area of at least 1000 mm² or at least 16,000 mm². In some embodiments, the smear has no more than a monolayer of cells over most of the smear and, optionally, a cell density equal to or greater than 80%.

In embodiments in which the sample is a blood sample, the method may further include the steps of, prior to the moving step: determining a parameter of the sample selected from a group consisting of hematocrit, white blood cell count, platelet count, sample storage container oxygen level, and sample storage container fill percentage; and adjusting movement of the smear tool based on the determined parameter.

Another aspect of the invention provides a method of creating a layer of cells on a surface including the following steps: dispensing on the surface a sample including cells suspended in a liquid; moving a smear tool along the surface through the sample; mixing at least a portion of the sample; and adhering the sample to the surface to thereby create a layer of cells. In some embodiments, the smear tool has a forward edge, and the engaging step includes the step of changing a relative angle between the forward edge and the surface and/or changing a distance between the forward edge and the surface during the moving step.

In some embodiments, the dispensing step includes the step of dispensing the sample onto the surface in a sample pattern that extends at least three times further in a first direction than in a direction perpendicular to the first direction. Examples of such sample patterns include two separate sample portions and a continuous shape.

Some embodiments include the optional step of monitoring a parameter of the sample, such as by measuring light transmittance through at least a portion of the sample or layer of cells. In such embodiments the moving step may include the step of controlling movement of the smear tool using closed loop feedback based on the parameter.

In some embodiments, the smear tool may be engaged with the sample prior to the mixing step such as by, e.g., moving the smear tool in a first direction along the surface to engage the smear tool with the sample, with the mixing step including the step of moving the smear tool in a direction other than the first direction after engaging the smear tool with the sample. Examples of mixing include oscillating the smear tool (e.g., at a frequency between about 1 Hz to about 100 Hz); moving the smear tool in at least two directions with respect to the surface; and changing a distance between the smear tool and the surface.

Some embodiments include the step of mixing at least a portion of the sample during the moving step. Once again, examples of such mixing include oscillating the smear tool (e.g., at a frequency between about 1 Hz to about 100 Hz); moving the smear tool in at least two directions with respect to the surface; and changing a distance between the smear tool and the surface.

In some embodiments, the moving step includes the step of varying a relative speed between the smear tool and the surface. The method may also include the step of accelerating drying of the monolayer after the adhering step.

The smear can have various shapes and sizes. In some embodiments, the adhering step includes the step of adhering the sample in a smear at least about 50 mm long. The smear may have an area of at least 1000 mm² or at least 16,000 mm². In some embodiments, the smear has no more than a monolayer of cells over most of the smear and, optionally, a cell density equal to or greater than 80%.

In embodiments in which the sample is a blood sample, the method may further include the steps of, prior to the moving step: determining a parameter of the sample selected from a group consisting of hematocrit, white blood cell count, platelet count, sample storage container oxygen level, and sample storage container fill percentage; and adjusting movement of the smear tool based on the determined parameter.

Yet another aspect of the invention provides an apparatus for creating a cell layer on a surface from a sample comprising cells suspended in a liquid, with the apparatus having: a surface; a smear blade; and a blade motion mechanism including a motor, a smear blade linkage and a controller configured to move the smear blade with respect to the surface along an X axis and along a Y axis perpendicular to the X axis to adhere the cells in a layer on the surface.

Some embodiments also have a sample dispenser adapted to dispense the sample onto the surface in a sample pattern that extends at least three times further in the X direction than in the Y direction. Examples of such sample patterns include two separate sample portions and a continuous shape.

Some embodiments also include a sample monitor adapted to monitor a parameter of the sample, such as a light transmittance monitor configured to monitor light transmittance through at least a portion of the sample (e.g., the cell layer on the surface). In some embodiments the monitor is configured to communicate the monitored parameter to the controller and the controller is further configured to control movement of the smear blade using closed loop feedback based on the parameter.

In some embodiments, the blade motion mechanism is adapted to apply a force to the surface with the smear blade. The smear blade may be adapted to flex when it applies a force to the surface. In some embodiments, the smear blade has a forward edge, and the blade motion mechanism is further adapted to permit the forward edge to change an angle with respect to the surface as the smear blade applies the force to the surface. Alternatively or additionally, the linkage may be adapted to flex when the smear blade applies a force to the surface.

In some embodiments, the smear blade has a forward edge with a non-linear portion, such as notches, a rough surface and/or a curve. At least a portion of the smear blade may be less hydrophilic than the surface.

In some embodiments, the blade motion mechanism is adapted to mix at least a portion of the sample as the smear blade moves with respect to the surface. The blade motion mechanism may also be adapted to move the smear blade toward or away from the surface as it moves in the X direction or the Y direction.

In some embodiments, the apparatus includes a sample dryer, such as a mechanism adapted to move warm gas over the sample.

Still another aspect of the invention provides an apparatus for creating a cell layer on a surface from a sample comprising cells suspended in a liquid, with the apparatus including: a surface; a smear blade; and a blade motion mechanism having a motor, a smear blade linkage and a controller configured to engage the smear blade against the surface with an engagement force and to move the smear blade with respect to the surface to adhere the cells in a layer on the surface, at least one of the smear blade and the linkage being adapted to flex to change an orientation of the smear blade with respect to the surface.

Some embodiments also have a sample dispenser adapted to dispense the sample onto the surface in a sample pattern that extends at least three times further in the X direction than in the Y direction. Examples of such sample patterns include two separate sample portions and a continuous shape.

Some embodiments also include a sample monitor adapted to monitor a parameter of the sample, such as a light transmittance monitor configured to monitor light transmittance through at least a portion of the sample (e.g., the cell layer on the surface). In some embodiments the monitor is configured to communicate the monitored parameter to the controller and the controller is further configured to control movement of the smear blade using closed loop feedback based on the parameter.

In some embodiments, the smear blade has a forward edge with a non-linear portion, such as notches, a rough surface and/or a curve. At least a portion of the smear blade may be less hydrophilic than the surface.

In some embodiments, the blade motion mechanism is adapted to mix at least a portion of the sample as the smear blade moves with respect to the surface. The blade motion mechanism may also be adapted to move the smear blade toward or away from the surface as it moves in the X direction or the Y direction.

In some embodiments, the apparatus includes a sample dryer, such as a mechanism adapted to move warm gas over the sample.

Another aspect of the invention provides a method of identifying a fetal cell, including the following steps: providing a maternal blood sample; and performing an in situ hybridization using at least one probe recognizing an RNA from an imprintable transcriptional RNA class. In some embodiments, performing an in situ hybridization includes the step of using at least one probe that recognizes an antisense, non-micro RNA selected from the group consisting of AIR, an antisense RNA to the IGF2r gene; MESTIT1, an antisense RNA to MEST; COPG2IT1, an antisense RNA to COPG2; IGF2AS, an antisense RNA to IGF2; KCNQ1OT1, an antisense RNA to KCNQ1; WT1AS, an antisense RNA to WT1; an antisense RNA to MKRN3; an antisense RNA to UBE3A; and GNAS, an antisense RNA to SANG, and a positive signal indicates the presence of a fetal cell. In some embodiments, performing an in situ hybridization procedure includes the step of using a probe that recognizes H9 and a positive signal indicates the presence of a fetal cell.

Still another aspect of the invention provides a method of identifying a female fetal cell, including the following steps: providing a maternal blood sample; and performing an in situ hybridization procedure using a TSIX probe and a XIST probe on the sample to generate signals wherein positive signals with the TSIX and XIST probes are indicative of the presence of fetal cellular material.

### BRIEF DESCRIPTION OF THE DRAWINGS

The novel features of the invention are set forth with particularity in the claims that follow. A better understanding of the features and advantages of the present invention will be obtained by reference to the following detailed description that sets forth illustrative embodiments, in which the principles of the invention are utilized, and the accompanying drawings of which:

FIG. 1 is a schematic illustration of part of an automated system for creating a layer (such as a monolayer) of cells according to an embodiment of the invention.

FIGS. 2A-2D show examples of initial movements of a cell smear tool after contacting a cell sample to promote mixing.

FIGS. 3A-3D show examples of movements of a cell smear tool while creating a layer of cells.

FIGS. 4A-4H show various configurations of smear tools for use with the automated system of FIG. 1.

FIG. 5A shows a schematic diagram of a sample of cells being smeared to generate a layer of cells.

FIG. 5B shows a computational fluid dynamic analysis of a sample of cells like the one shown in FIG. 5A using a straight smear blade.

FIG. 6 shows a computation fluid dynamic analysis similar to the analysis in FIG. 5 using a smear blade with three notches according to one aspect of the disclosure.

FIG. 7 shows a smear blade with a flexible linkage.

FIG. 8A shows a side view of a smear blade with a separate spine, flexure, and forward edge.

FIG. 8B shows a front view of the same smear blade.

FIG. 9A shows a side view of a flexible smear blade having a spine.

FIG. 9B shows a front view of the same smear blade as shown in FIG. 9A.

FIG. 10A shows how a smear blade having a mating spine, flexure, and forward edge can flex.

FIG. 10B shows a front view of the same blade as shown in FIG. 10A.

FIG. 10C shows in cross section through a layer of flexure and forward edge how the same smear blade as shown in FIGS. 10A and 10B can flex by twisting about a central axis.

FIG. 11 shows a flexible smear blade like the one shown in FIGS. 10A-C that flexes to contact a cell sample and a substrate when a force is applied.

FIG. 12 shows a front view of a flexible smear blade and a substrate.

FIG. 13 shows a side view of a flexible smear blade attached to the smear head. The smear head will move can move with the smear blade in different directions and configurations relative to the substrate. The substrate can also or alternatively be moved relative to the smear head and smear blade.

FIG. 14 shows a cell sample being applied to a substrate.

FIG. 15 shows a flexible smear blade ready to contact a cell sample and substrate like the ones shown in FIG. 14.

FIG. 16 shows a cell smear generated by a cell smear tool according to one aspect of the disclosure.

FIG. 17 and FIG. 18 show fluid smear patterns that could be generated according to one aspect of the invention.

FIG. 19 is a schematic representation of a layer of blood cells generated according to one aspect of the invention.

FIG. 20 is a schematic representation of a layer of red and white blood cells created using a flexure blade after an enrichment procedure for rare cells.

FIG. 21 is a schematic representation of a layer of red and white blood cells created using a flexure blade after an enrichment procedure for rare cells similar to the procedure used in FIG. 20, but with a different angle of the smear head.

FIG. 22, FIG. 23 and FIG. 24 are photographs of blood smears made according to embodiments of the invention.

FIGS. 25A and 25B show sample deposition patterns according to embodiments of the invention.

### DETAILED DESCRIPTION OF THE INVENTION

Aspects of the invention include improvements in creating and analyzing a blood smear. While the precision of prior automated blood smear tools may have been adequate for isolating and identifying blood components found in large numbers in a blood sample, as noted above, the percentage of fetal cells to total cells in a sample of circulating maternal blood is small. Greater precision in separation and distribution of a blood sample's cells in a smear will improve the chances of automated or manual identification of the few fetal cells in the sample.

For example, evenness of the cell layer (which is ideally a monolayer) across the entire smear is desirable, particularly when the cells of interest are rare. Smear areas that are too thick (e.g., thicker than a monolayer) will have overlapping cells that might obscure the cells of interest. Smear areas that are too dense may make the individual cells difficult to distinguish. Smear areas that are too sparse, i.e., areas in which the distance between individual cells is too great, will complicate the inspection and identification processes. One aspect of the invention therefore provides methods and devices for improving the deposition of a blood sample into an even layer or monolayer of appropriate density.

The likelihood of finding a sufficient number of rare cells in a sample may be increased by increasing the size of the sample. The larger the sample, however, the more difficult it is to smear the sample into a even layer or monolayer. Another aspect of the invention, therefore, is an automated device capable of creating a cell layer with a usable area that can be 50 or more millimeters long (20 mm×50 mm=1000 mm²). This is an order of magnitude larger area than those created using current manual or automated smearing techniques (manual is 2 mm×20 mm=40 mm²). In some cases, even larger area smears (125 mm×125 mm=15,625 mm²) are created.

Furthermore, the act of moving the blood relative to a surface to form a smear causes flow patterns to emerge that serve to move the cell populations both parallel to and normal to the main direction of the smear. Different cell types are affected differently by these induced flow patterns. This differential action of the flow patterns on the different cell types manifests as non-homogeneous distribution of the cell types parallel to and normal to the main direction of the smear. For example, it has been noted that white blood cells tend to have a higher density of distribution near the edges of the smear than near the center of the smear. Computational fluid dynamics (CFD) analyses show that a flow toward the ends of the smear tool (the outer edges of the smear) is induced during the smearing process. Yet another aspect of the invention therefore counteracts deleterious flow patterns and creates positive flow patterns within the sample to mix and distribute cells more evenly throughout the sample and, thus, throughout the smear.

The process of forming a cell layer may have the steps of treating a cell sample; placing a cell sample on a substrate; contacting the cell sample with the smear blade; creating a meniscus between an edge of the cell sample, the smear tool, and the substrate; moving the smear blade relative to the substrate to create a smear; and drying the cell smear. In one embodiment, the invention describes a process in which the relative motion between the substrate and the smear blade is performed in more than a single axis. Assuming that X is in the direction of the smear to be made and Y is in the plane of the monolayer and normal to the main direction of smear it is possible to move the smear blade in the X, Y, and/or Z, directions relative to the substrate. The substrate may move in the X, Y, and/or Z directions relative to the smear blade. The movements of the substrate may be controlled using a suitable motion system with a motion controller, software, and actuator.

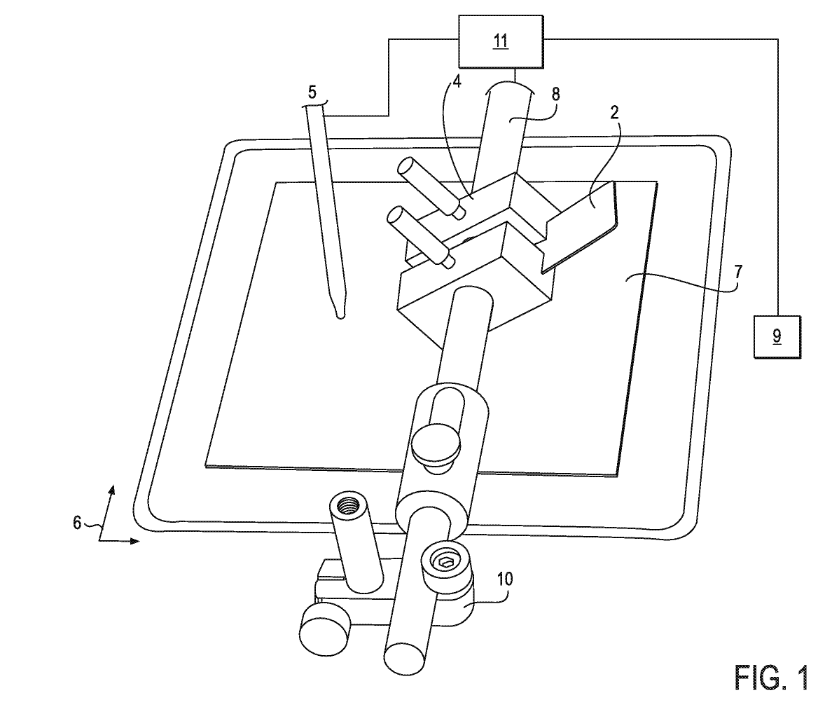

FIG. 1 shows a smear system to create a cell layer from a cell sample placed on a substrate. Smear blade 2 may be moved by a motor and actuator 10 via a linkage including a smear head 4 and an axle 8. In the configuration shown in FIG. 1, blade 2 is currently disengaged from the substrate. Smear blade 2 can be rotated partway around axle 8 to engage a cell sample deposited on a substrate 3 on base 7 by a dispenser. (The dispenser and the cell sample are not shown in this view). Movement of smear blade 2 and axle 8 relative to substrate 3 may be controlled by a controller 11 and associated software. Alternatively, the substrate 3 or base 7 may be moved relative to smear blade 2 as indicated by arrow 6.

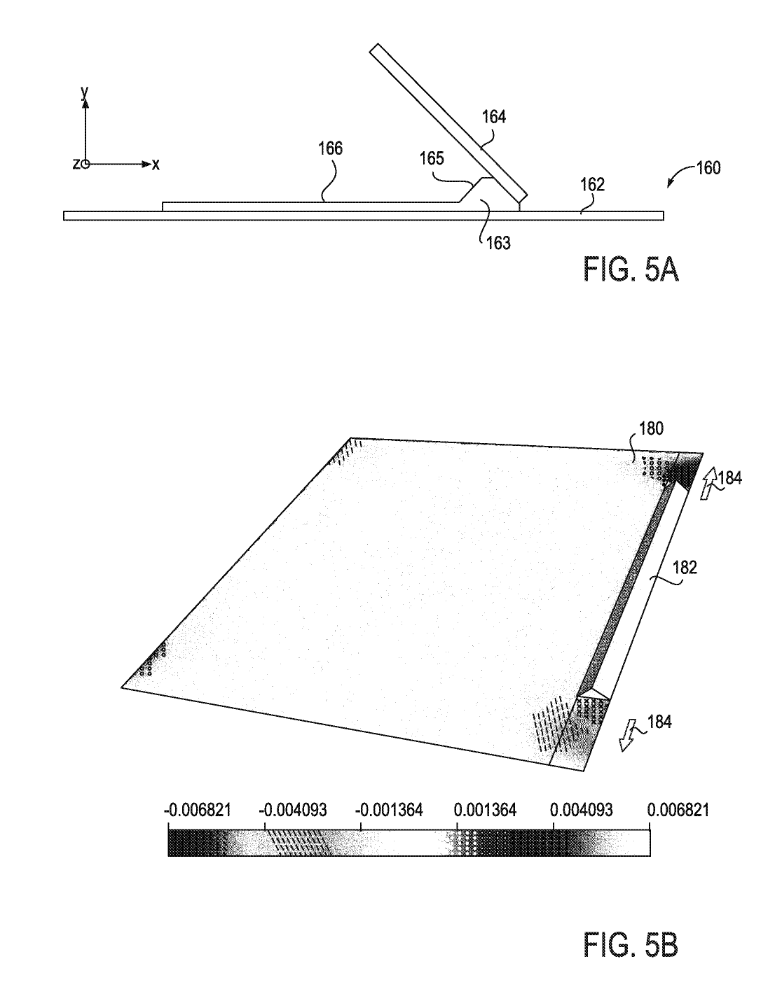

As the smear blade engages the cell sample or blood drop on the substrate, the sample flattens and spreads, and the meniscus at the sample's air interface extends from the substrate to the smear blade. As the smear blade moves across the substrate, the surface tension of the liquid in the sample causes the sample to follow the blade, and friction between the liquid and cells in the sample causes a portion of the sample to adhere to the substrate. For example, FIG. 11 shows a smear apparatus 330 with a smear blade 334 on substrate 332 with cell sample 342 applied to substrate 332 before the start of cell smearing. A meniscus 344 at the air interface of cell sample 342 extends from smear blade 334 to substrate 332. FIG. 5A is another example showing a smear blade 164 (temporarily lifted off substrate 162) depositing a sample into a smear 166. The as-yet unsmeared portion 163 of the sample has a meniscus 165 extending between substrate 162 and smear blade 164.

Even movement of the smear blade across the substrate may promote uniform smear thickness and cell deposition. In addition, precise alignment between the forward edge of the smear blade and the surface of the substrate will also promote even deposition. One aspect of the invention therefore provides a flexible connection between the smear blade and its motion mechanism to ensure proper orientation of the blade with respect to the substrate and to reduce chatter during movement of the blade across the substrate.

The smear blade may be configured to create a line of contact along essentially the entire distance between the forward edge of the blade substrate. The line of contact may be maintained during the duration of the droplet pickup and subsequent smearing process. Contact between the substrate and smear blade may be maintained without inducing vibration or chatter between the substrate and the blade. Adding a flexible segment to the smear blade allows this non-chattering contact to be maintained without the necessity of adding active control systems or expensive mechanical components to the either the substrate mount or the smear blade mount. The flexure allows for low precision mechanics to be utilized in the smear apparatus, which may keep costs low. In another embodiment, a unique flexure design may be utilized to properly orient the smear blade with respect to the substrate (i.e., change its angle relative to the substrate) and to maintain a specified contact force between the smear blade and the substrate during movement across the substrate. The flexible feature smear blade may comprise a spine, a flexure, and a blade. The flexure may be a segment of flexible material between the rigid spine and rigid smear blade.

In another embodiment, the blade may be incorporated into the flexure material and in this configuration the smear blade will have only two components: the spine and the flexure/blade combination.

In one embodiment, the smear blade has a blade that is distinct from the flexure. The flexure is firmly affixed to both the spine and the blade. The amount of force required to bend the flexure to accommodate height variations is controlled by adjusting the material of the flexure, material (web) thickness, material (web) length, material (web) width, and/or the number of webs in the flexure. The mechanical properties of the flexure can be controlled by 1). The length of the flexure arms, 2). The thickness of the flexure arms, 3). The width of the flexure arms, and 4). Young's modulus of the material. In one example, the length of the flexure arms is 15 mm, the width of the flexure arms is 5 mm, the thickness of the flexure arms is 0.5 mm, and the flexure material is sheet styrene. The opening through the flexure improves the flexure's ability to accommodate relative twist between the substrate surface and blade's wetted edge. In some embodiments the flexible material may comprise a hole.

In another embodiment, the smear blade may have a blade that is incorporated into the flexure. In some embodiments the flexible material may comprise a hole.

The flexure design allows the relative angle between the substrate and smear blade to be adjusted using only relative Z motion between the substrate and the smear blade. The properties of the flexure can be controlled by choosing the material, the thickness, the presence or absence of an opening, and the length and width of any opening. The flexure may be made from any material that provides the necessary strength and flexibility. The flexure may be made from low cost sheet plastic such as polystyrene, PETG, or HDPE.

FIG. 7 shows a smear blade with flexure 221 between the spine 224 and the smear blade 226 ready to be placed on substrate 220. The flexure may have an opening or hole 228. Opening 228 may make the blade more flexible, lighter, or less expensive to manufacture.

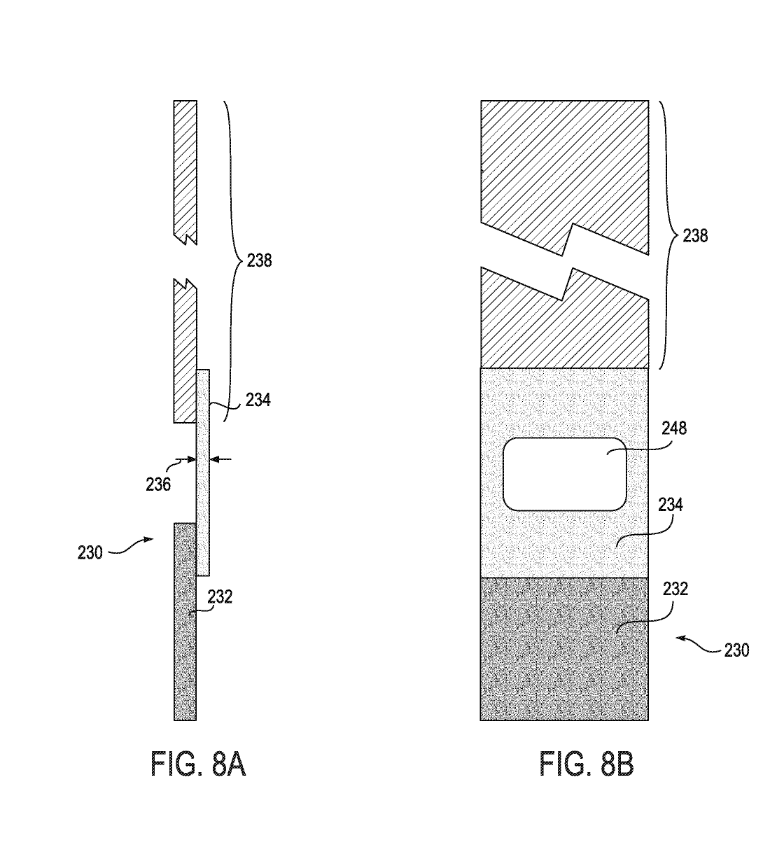

FIGS. 8A and 8B show a side and front view of blade 230 with smear blade 232 and a flexible linkage made up of a flexure 234, and a rigid spine 238. Spine 238 may connect the smear blade to a smear head or other motion mechanism of a smear apparatus, such as the one shown in FIG. 1. The flexure may have features contributing to its flexibility. For example, as shown in FIG. 8B, flexure 230 has an optional opening 248, an edge width 246 with a defined width, and an opening or hole height 252. As another example, the opening may be replaced by a web.

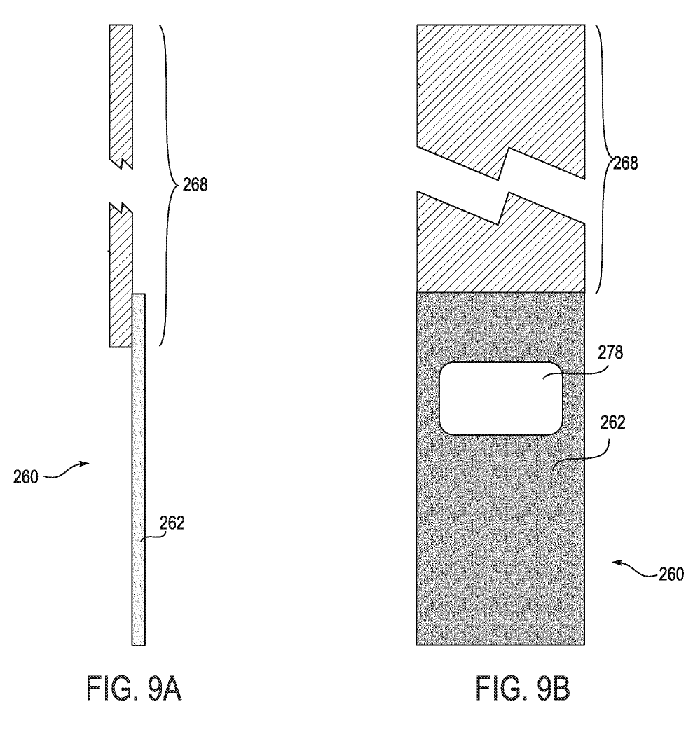

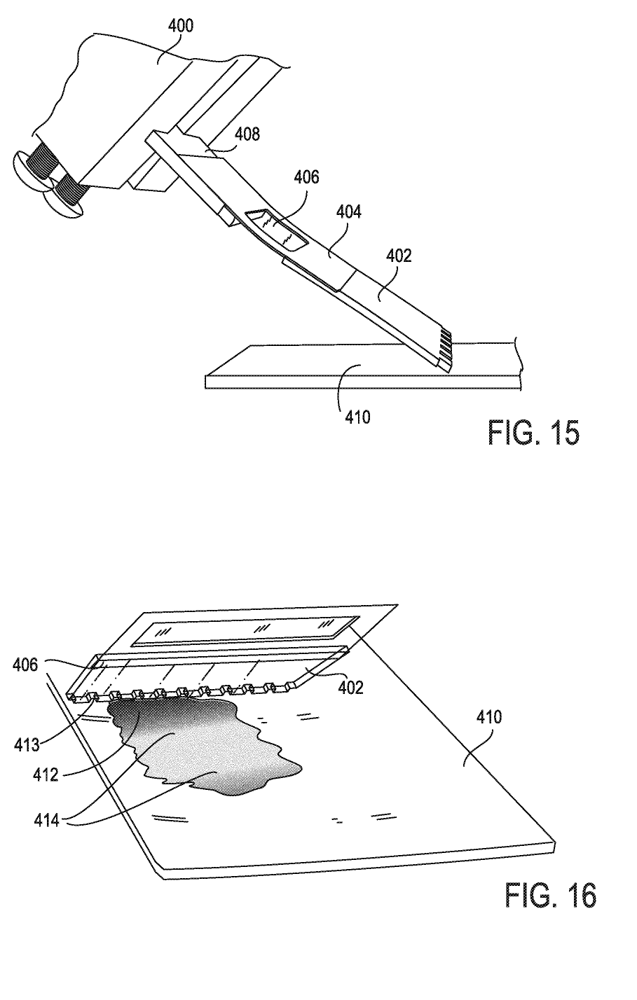

FIGS. 9A and 9B show a side and front view of an embodiment in which the flexible linkage is built into the smear blade. In FIGS. 9A and 9B, blade 260 is made of a flexible material. An optional opening 278 to provide additional flexibility. Spine 268 may connect the smear blade to a smear head or other motion mechanism of a smear apparatus, such as the one shown in FIG. 1 and the one shown partially in FIG. 15.

The smear blade may flex in two directions. The flex allows the blade to maintain contact with the substrate by the application of a moderate force without requiring perfect alignment between the blade and the substrate. This reduces the precision required for aligning the blade and substrate, which can improve quality and reduce production costs.

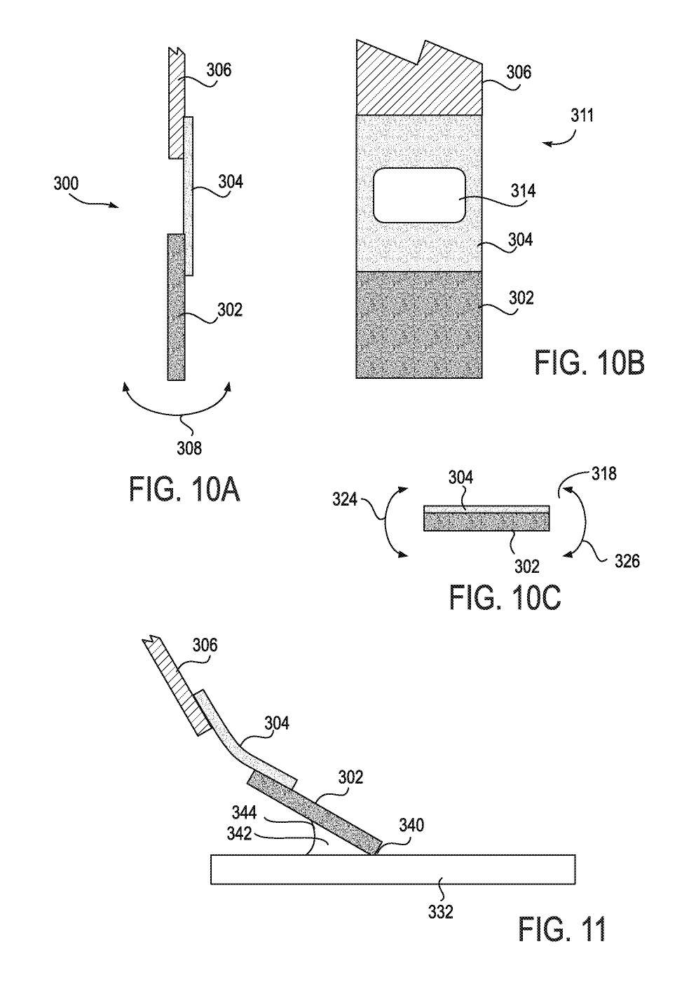

An example of the degrees of freedom (allowed flex) that can be provided by the flexure design is shown in FIGS. 10A-C. FIGS. 10A, 10B, and 10C show a side, front, and cross section through a blade 300 with a spine 306, and a flexure 304. Flexure 304 has hole or opening 314. Flexure 304 can flex along its long axis (308) as shown in FIG. 10A and around its center (324, 326) as shown in FIG. 10C. The twist may be through just the flexure or may be through the flexure and the blade. The blade and flexure materials may be chosen to be sufficiently flexible to bend and twist but sufficiently strong to smear a cell sample on a substrate.

FIG. 11 shows the embodiment of the smear blade and flexible linkage of FIGS. 10A-C in use to create a layer of cells on a substrate 332. The blade motion mechanism, including spine 306, causes the forward edge 340 of smear blade 302 to exert a downward force on the substrate 332, thereby causing flexure 304 to flex. Any misalignment between edge 340 and substrate 332 will also cause smear blade 302 to twist as the force is applied to thereby align edge 340 with substrate 332. The bending shown in FIG. 11 will also enable edge 340 to stably contact substrate 332 as the blade moves across the substrate.

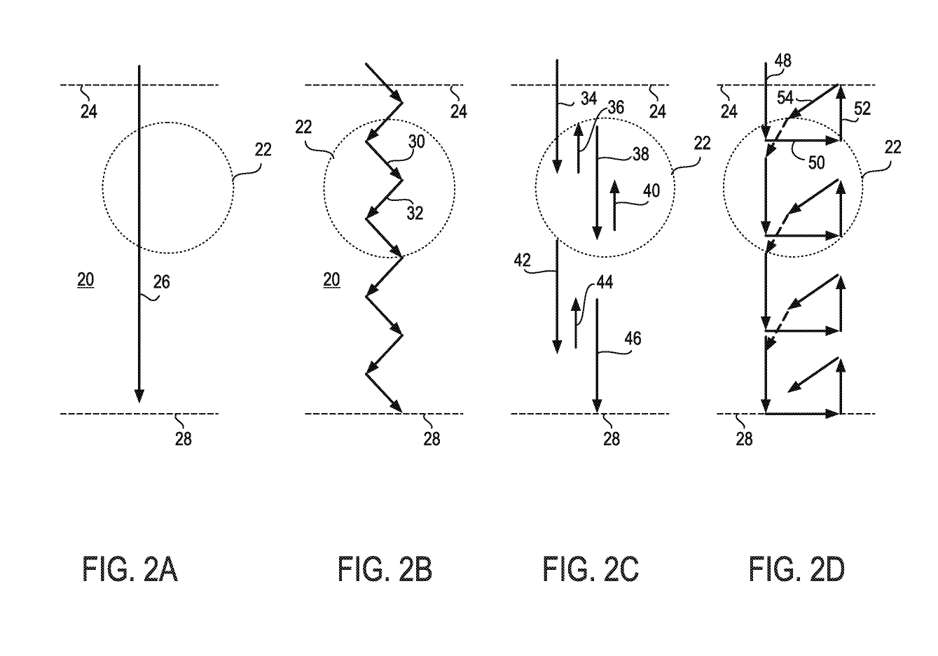

Distribution of the cells in the smear may be improved by mixing the sample prior to and/or during the smearing process. For example, the cell sample may be mixed by oscillation of the sample (e.g., at a frequency from about 1 Hz to about 100 Hz) by the smear blade after it engages the sample. FIGS. 2A-2D show movements the smear blade may make as it first contacts the cell sample. FIG. 2A shows a cell sample 22 appearing as a drop after being placed on a substrate. The wet or forward edge of the smear blade is placed at position 24 on the substrate 20 with the smear blade angled downward toward the drop to contact and flatten the drop. The smear blade may be moved a short distance along the X axis 26 which is in the direction opposite to the direction in which the smear will be moved during the smearing operation in order to prepare the drop for smearing. Note that the distance the smear blade moves is very short compared with the distance of the smear length. The smear blade stops at stop 28.

Moving the smear blade in both the X and Y directions may mix the cell suspension to promote homogenous cell population distribution and improve the uniformity of the meniscus height prior to the start of the smear. FIG. 2B shows a cell sample 22 appearing as a drop after being placed on a substrate 20 as in FIG. 2A. The wet or forward edge of the smear blade will be placed at position 24 on the substrate and the smear blade angled downward toward the drop to contact and flatten the drop. The smear blade may be moved in a zigzag pattern 30, 32 (i.e., in both X and Y directions) to mix the contents of the cell sample. FIG. 2C shows movement of a blade in a complex back-and- forth motion 34/36/38/40/42/44/46 (i.e., only in the X direction) to mix the cell contents. FIG. 2D depicts blade movement in a circular pattern 50/52/54. The blade can be moved a short distance and the circular pattern repeated.

These patterns may be applied to the cell sample alone or the patterns may be combined to prepare the drop for smearing. The speed of the blade or substrate movement may be varied.

In another embodiment, moving the smear blade in the Z direction (normal to what will become the plane of the smear) allows the system to change the angle of the smear blade or to create a specified gap or force between the substrate and the blade, either by raising the smear blade or by changing its angle. A theta control on the smear blade allows the system to adjust the relative angle between the substrate and the smear blade. This angle may be varied during the drop preparation for smearing.

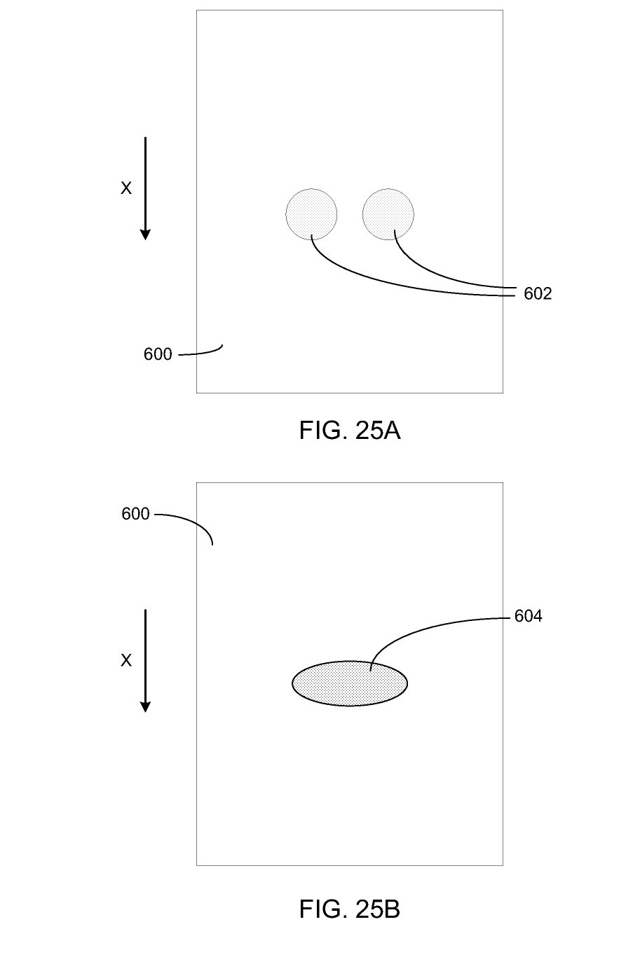

Yet another aspect of the invention is a sample dispensing pattern that provides for formation of a more even cell layer, particularly for larger cell samples. In one embodiment, the cell sample is dispensed on the surface in a sample pattern that extends further in a first direction than in a direction perpendicular to the first direction. In one example, the cell sample pattern may extend at least three times further in a first direction than in the perpendicular direction. The cell sample may be dispensed onto the surface in two or more separate portions. The two or more portions may be dispensed along one or more lines relative to the Y direction. The cell sample may be dispensed in a continuous shape such as in one or more lines. Examples of cell dispensing patterns are shown in FIGS. 25A and 25B. In FIG. 25A, the sample 602 has been deposited on substrate 600 in two droplets together extending more in a direction perpendicular to the X direction of smear blade movement than in the X direction. In FIG. 25B, the sample has been dispensed in a continuous shape 602 extending more in a direction perpendicular to the X direction of smear blade movement than in the X direction. Distributing the sample across the substrate prior to smearing helps provide a more even cell layer.

In some embodiments, any parameter of the sample can be monitored. A sensor or monitor 9 is shown schematically in FIG. 1. The light transmittance through at least a portion of the cell sample can be measured to determine, e.g., sample thickness. In another embodiment, closed loop feedback from the sensor can be used to control operation of the smear tool to make adjustments to any part of the system, including but not limited to speed, blade/substrate direction (XYZ vector combination), substrate/blade relative angle, substrate/blade force, and/or substrate blade gap. Closed loop feedback can be used to monitor light transmittance or height uniformity. Thus, sensor 9 is shown schematically as connected to controller 11 to provide this feedback control. The speed of the smear blade can be controlled or changed. Assuming that X is the main axis of smearing (long axis) it is possible to vary the relative speed in the X direction between the substrate and the blade in order to control the density of particle application. Faster speed deposits particles in higher density. Slower speed deposits particles at a lower packing density. The speed in the X direction of the smear blade relative to the substrate during the smear allows the system to vary the density and quality of the cell layer. A monolayer density of 80% or more is provided in some embodiments.

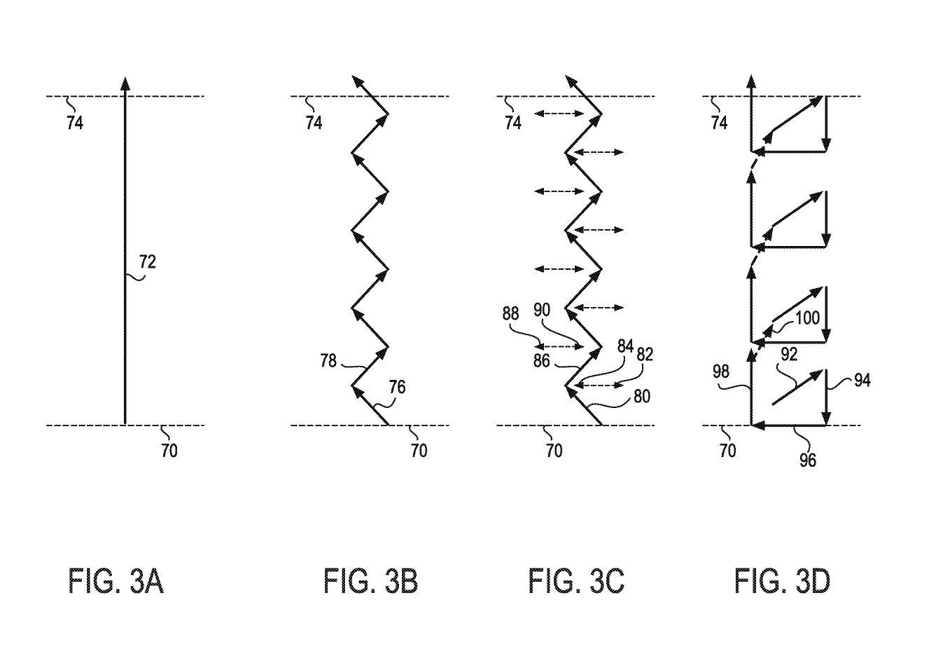

The density of the cell layer may be monitored during the smear, and the speed may be adjusted based on the measured density to optimize the uniformity of cell distribution along the main (X) direction of the smear. The direction(s) in which the smear blade moves relative to the substrate or the substrate moves relative to the smear blade can be controlled or changed. After picking up the cell sample drop and initial meniscus creation, the smear proceeds. The smear blade may move in a straight line 72 as shown in FIG. 3A from an initial blade location 70 to an end blade location 74. Moving the smear blade in both the X and Y directions mixes and induces flow patterns in the cell suspension that serve to maintain the cells in suspension, providing more control over the time and location where they are deposited onto the substrate. FIGS. 3B shows a zigzag smear blade pattern 76/78 from an initial blade location 70 to an end blade location 74. FIG. 3C shows a zigzag smear blade pattern 80/86 combined with a Y axis motion 82/84 and 88/90. FIG. 3D depicts a smear blade movement that is roughly circular 92/94/96 and repeated 98/100 as the smear blade moves along the X axis. Alternatively, the substrate can use the same motions relative to the smear blade.

Moving the blade or substrate in Z direction (normal to the plane of the smear) allows the system to change the angle of the smear blade or to create and maintain a specified gap or force between the substrate and the blade. A theta control on the smear blade allows the system to adjust the relative angle between the substrate and the smear blade. This angle may be varied while the smear is in progress to control the quality and density of cells deposited on the substrate.

For all motion parameters the cell layer density may be monitored during the smear and adjustments may be made on the fly to speed, smear direction (XYZ vector combination), substrate/blade relative angle, substrate/blade force, and/or substrate blade gap. Any of the motions described above for generating the meniscus may be applied to improve the quality of the smear. Any parameter may be checked or monitored to improve the quality of the meniscus or the smear, including but not limited to hematocrit, white blood cell count, platelet count, sample storage container oxygen level, and sample storage container fill percentage. Adjustment of the cell density being applied while the smear is occurring optimizes the uniformity and homogeneity of the smear.

In various embodiments, novel edge designs for the wet or forward edge of the smear blade, use of materials with specific qualities, and/or specially designed blade shapes may improve the quality of the smear. Novel smear blade configurations and geometries can be used to improve homogeneity of the cell population distributions. The following paragraphs provide examples of these embodiments.

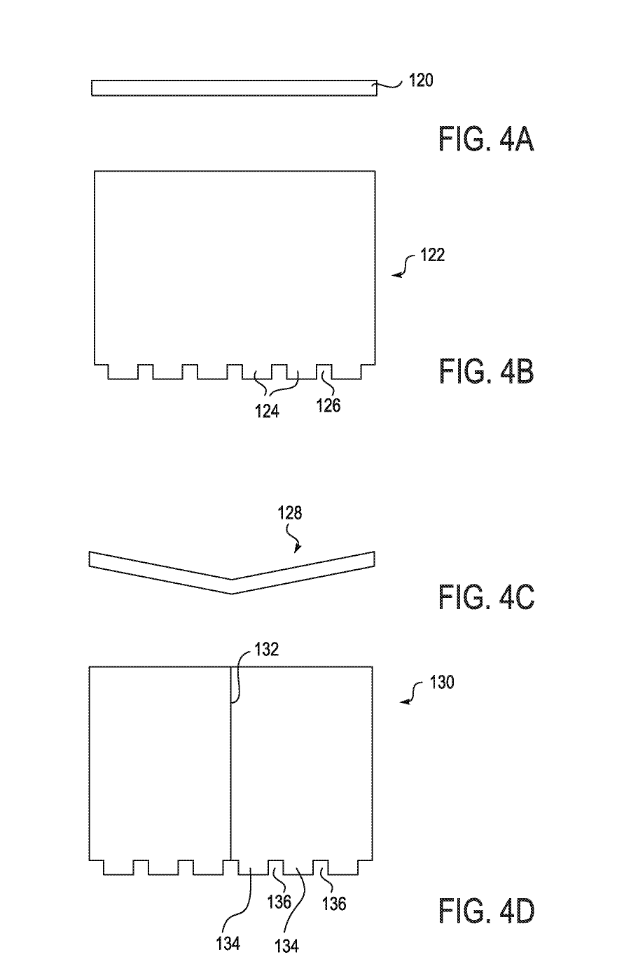

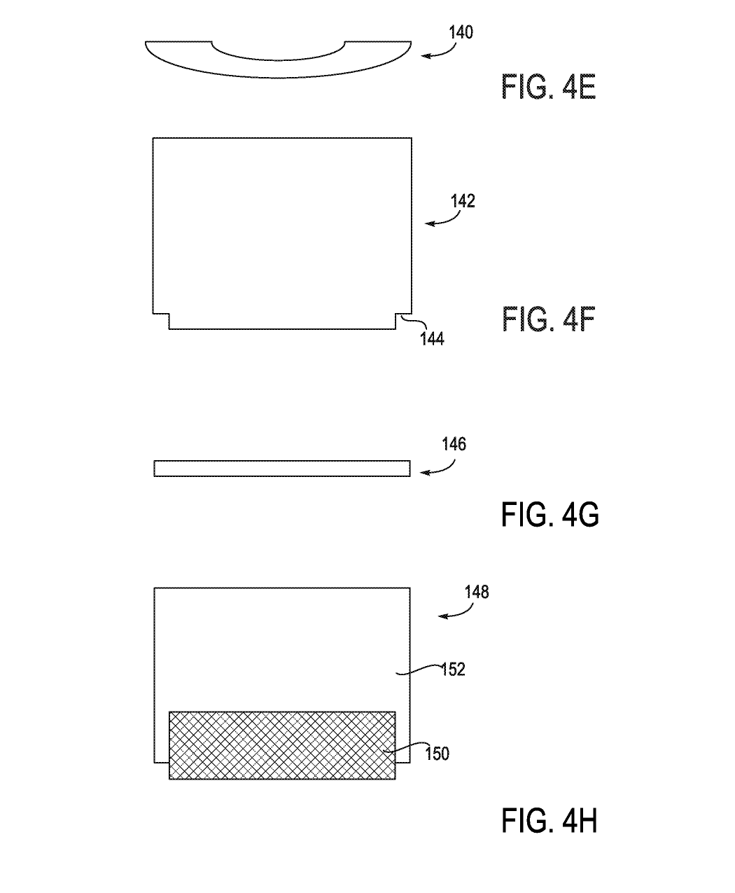

Notches in the smear blade's wet edge serve to break up and limit the size, speed, and drag force related to flows which are induced in the meniscus during smear. The notches (perforations) may be made partially or completely through the smear blade. FIG. 4A (top view) and FIG. 4B (front view) show a smear blade 120, 122. FIG. 4B shows notches 126 and tabs 124 through the wet or forward blade edge of smear blade 122.

The smear blade may have any unique geometry that improves the cell layer quality. Blade shapes that induce flows counter to and of the same magnitude as the outward (toward smear edges) flow may be used to improve the homogeneity of the cell distributions in the smear. Examples are wedges and curves designed to induce flows that distribute cells in a uniform and homogenous manner.

FIG. 4C (top view) and FIG. 4D (front view) show a wedge shaped smear blade 128, 130. FIG. 4D shows bend 132. Any of the qualities from any embodiment can be combined with any other embodiment. FIG. 4D shows notches 136 and tabs 134 though the wet or forward blade edge of smear blade 130. FIGS. 4E (top view) and FIG. 4F (front view) show curved blades 140, 142 with notches 144.

A roughened surface on the smear blade at the point where the blade contacts the meniscus (forward edge) serves to break up induced flow patterns in the meniscus during smear. Breaking up these induced flows may improve the homogeneity of the cell distributions in the smear. FIG. 4G (top view) and 4H (front view) show a blade 146, 148. FIG. 4H shows a blade with a spine 152 and a forward edge with a roughened surface 150. The roughened surface can be made from either the same or a different material from the spine.

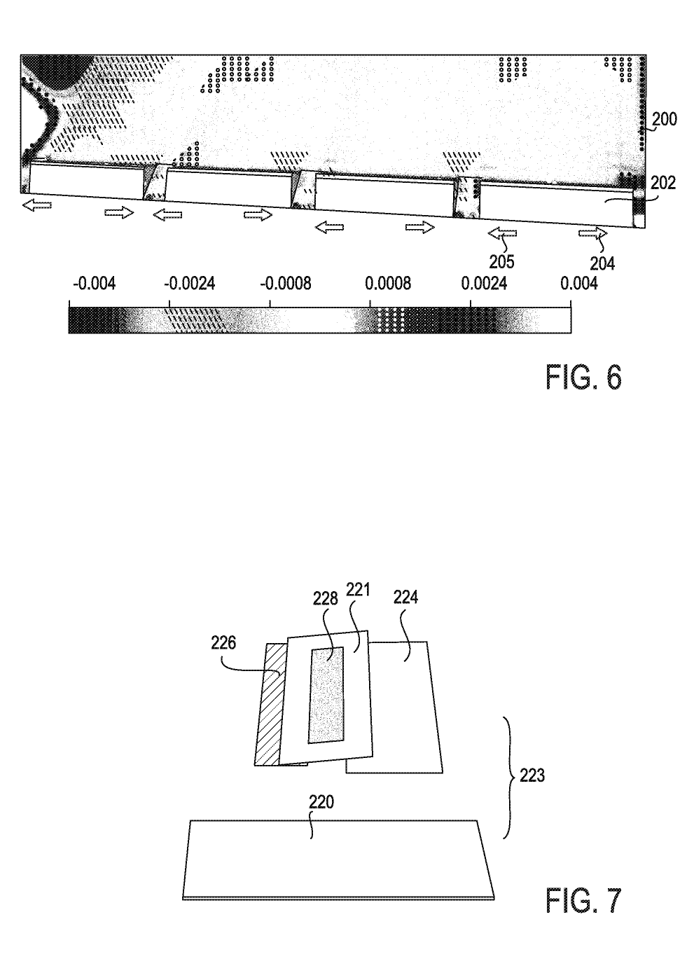

Computational fluid dynamics analyses can be used to show fluid movements during smearing. FIG. 5A shows setup 160 with smear blade 164 moving along substrate 162 to generate fluid layer 166. Fluid velocity is measured in the long direction of the blade. FIG. 5B shows fluid velocities in a fluid smear using a single wide smear blade (20 mm wide) 182 moving fluid 180. (A scale of velocities is shown at the bottom of the figure.) Outward 184 fluid flow (hatched marks, slashes, and circles) is generated in the meniscus behind the smear blade. This outward flow creates drag on the particles in suspension. The induced drag will be different for different particle populations and will tend to act as a separating force, with smaller denser objects falling more quickly out of suspension. FIG. 6 shows fluid velocities in a smear using a blade 202 with 3 slots (each 4.5 mm wide) moving fluid 200 that is generated in the meniscus behind each smear blade. Outward fluid flow 204, 205 is altered by the perforations. At the junctions of adjacent blades the induced flows cancel and thus the drag force induced on the suspended particles is reduced. In addition the magnitude of the induced flow speed is lower in a perforated smear blade (e.g. approximately 4 mm/sec at the ends of each sub-blade in this model but approximately 7 mm/sec in the single 20 mm wide blade).

The blade and substrate may comprise the same material or the materials may be different. Either or both may be coated or uncoated. In one embodiment the blade and substrate have different hydrophilic properties. The different hydrophilic properties may help increase the amount of material deposited in the monolayer due to the difference in affinity of the solution/sample for the substrate vs. the blade surfaces. Blades created using materials that are slightly less hydrophilic than the substrate may serve to increase the amount of material deposited in the cell layer due to the differences in affinity that the water has for the substrate vs. the blade surfaces. Fluid (water) will adhere better to the substrate more than to the smear blade. The blade and substrate can be any suitable material, including but not limited to fused silica, glass, other silicon containing materials such as cement or ceramic, a polymer such as acetyl copolymer, polycarbonate, polydimethylsiloxane (PDMS), polyester (e.g. polyethylene terephthalate (Mylar®), polytetrafluoroethylene (“PTFE”; Telfon®), vinyl, and/or stainless steel. The smear head may be rectangular notched glass, triangle notched glass, polished smooth glass, smooth glass scribed and broken per conventional glass cutting techniques, roughed edge glass to 200 grit, positively charged plastic, or negatively charged plastic.

Various parameters may be controlled or changed during the smear process.

Moving the smear blade relative to the substrate and blood droplet in both X and Y directions allows the creation of a uniform density of cells of the monolayer.

Moving the smear blade relative to the substrate and blood droplet in both X and Y directions allows the cell suspension to be mixed during the smear process to promote homogeneous cell population distributions.

The smear blade made by moved relative to the substrate and/or the substrate may be moved relative to the smear blade.

Control and change of motion of the smear blade with the flexure design in the Z axis controls force and relative angle between the substrate and the smear blade (e.g. the theta angle of the blade relative to the substrate).

As smearing takes place, relative speed, angle, gap, and force between the spreader blade and the substrate can be controlled.

Closed loop feedback may be used to measure cell distribution uniformity and make changes to the control parameters.

Moving the smear blade relative to the substrate and blood droplet in both the X and Y axes causes the cell suspension to be mixed, promoting homogeneous cell population distributions.

Moving the smear blade relative to the substrate and blood droplet in both the X and Y axes keeps cells suspended rather than dropping them onto the substrate under the dispensed suspension.

A fast cell layer/smear drying speed can improve smear/cell quality. Quickly drying the monolayer after the cells have been deposited on the substrate allows the removal of the solvent from the monolayer faster than the cells can react to the loss of solvent. This improves the uniformity of the cell morphology across the smear due to the fact that all cells experience the same osmolarity change during drying. The uniform morphology improves the ability of automated digital microscopy to identify cells of interest in the resulting monolayer. Allowing the slide to dry without assistance may result in the edges of the smear drying before the center of the smear dries. This subjects the cells at the center of the slide to osmolarity changes of a larger magnitude and over a longer time than are changes experienced by cells at the edges of the slide. Thus the cells in the center of the slide end up with a different morphology than do the cells at the edges of the slide. FIG. 1 shows sample dryer 5 which may dry a cell smear immediately after the cell smear is created.

After drying, the slides can be placed directly into an imaging system, or the cells can be subject to a chemical process, including but not limited to antibody staining or FISH. These processes can be automated with any compatible apparatus (e.g. Mai Tai Automated Hybridization Station from SciGene Corp).

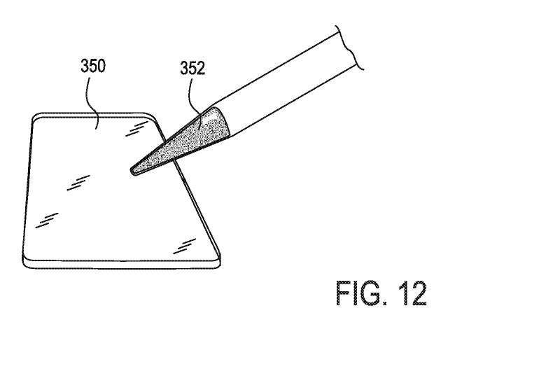

FIGS. 12-18 show a cell smear according to one aspect of the disclosure. The smear blade and substrate are placed onto the automated smearing tool.

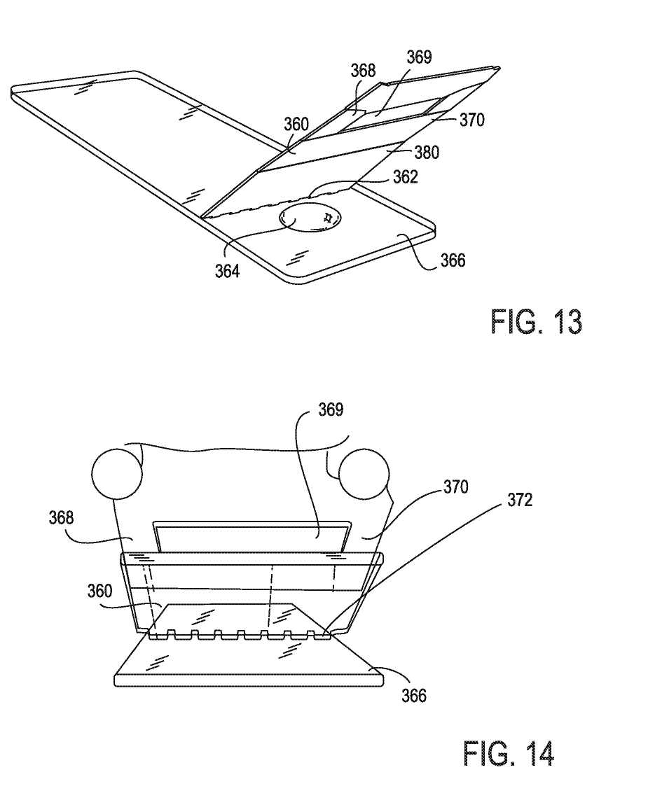

FIG. 14 shows a front view of smear blade 360 attached to an automated smear apparatus and contacting substrate 366. Smear blade 360 has a flexure 368, 370 with a hole or opening 369 and notches 372. FIG. 15 shows a side view of smear tool attached to an automated smear apparatus 400 by spine 408 and contacting substrate 410 with forward edge/blade 402. The smear tool has an opening 406 in flexure 404. FIG. 12 shows a cell sample 352 being placed on substrate 350. FIG. 13 shows smear tool 360 attached to the automated cell apparatus. Smear blade 363 is aligned with cell sample 364 on substrate 366. Smear blade 363 has a flexure 368 with a hole or opening 369, a flexure/forward edge overlap region 360, and a forward or blade edge 380 with notches 362. The smear blade is moved relative to the substrate and the blood droplet in order to create a meniscus between the spreading blade and the substrate.

FIG. 16 shows smear tool 406 with forward edge/blade 402 with notches 413 spreading cell sample 412 to create cell layer 414 on substrate 410. The substrate is moved relative to the smear blade to create the monolayer of cells.

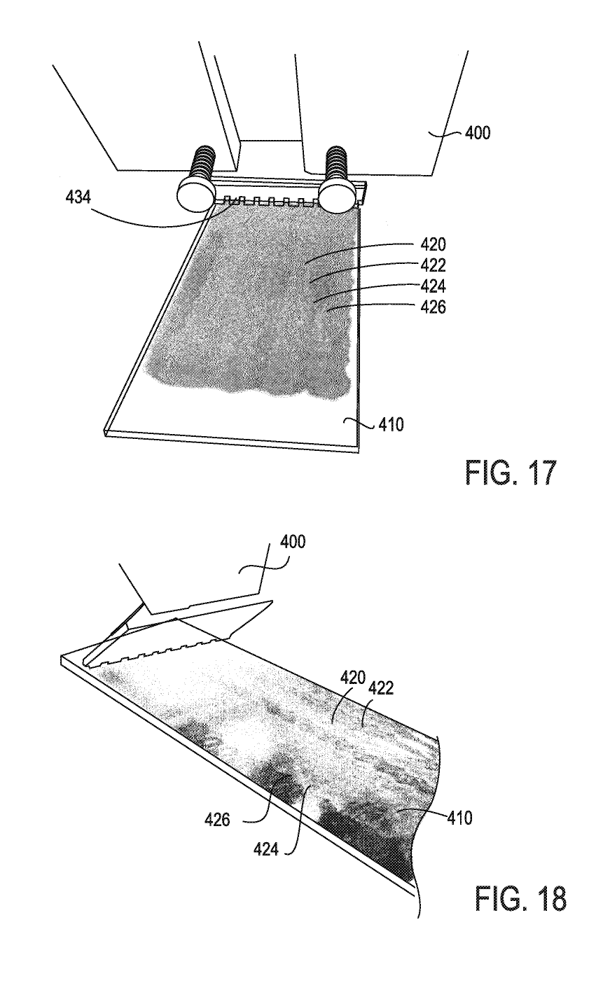

FIGS. 17 and 18 show smears generated on substrate 410 to create fluid movements reflected in fluid/cell layer 420, 422, 424, and 426 on substrate 410 according to one embodiment of the current invention. FIG. 17 shows smear blade 434 attached to smear head 400.

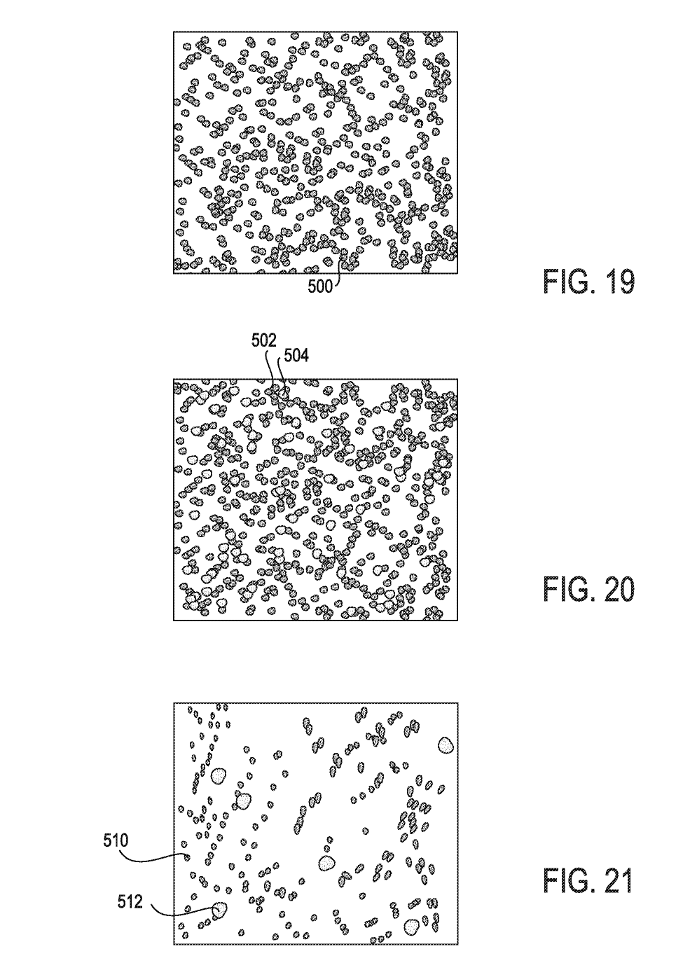

FIGS. 19-21 show schematic diagrams of actual results obtained after performing cell smears using methods and apparatus according to the disclosure.

In some embodiments, the cell sample may be treated before being deposited on the surface or substrate. The process may start with a sample which contains the cells of interest suspended in a solvent that may also contain additives intended to improve the appearance the cells, improve the distribution of cells on the substrate, reduce cell clumping, or provide a stain or other method of identifying a unique characteristic of the cells under review. A solvent as described in U.S. patent application 13/046,543, filed Mar. 11, 2011, may be used. The solvent may comprise detergents to separate cells (e.g. F-68), (other) glass forming lipid membrane stabilizers (e.g. maltose, trehalose), (other) Hofmeister series protein stabilizers (e.g. fluoride, phosphate and/or sulfate salts), other neutrophil stabilizers (e.g. pseudoephedrine), and/or other shear reducing components (e.g. albumin and/or dextran), instead of or in addition to any of the additives/solvents listed in U.S. patent application 13/046,543, filed Mar. 11, 2011.

The suspension may also contain other solid particles such as cells that are not of interest, reference standard particles, or non-visible colloidal particles. The total volume of sample may range from about 10 μl up to and including about 50 ml. The percentage of the suspension that is comprised of solid particles may range from 5% to 80%.

The custom chemistry of the cell suspension may address issues related to the degradation of cells during processing (mechanical manipulation of the cells).

The chemistry may promote cell adhesion and improve the uniformity of the morphology of the cells.

The cells may be tagged or stained in suspension prior to deposition. The tags or stains may include any stains commonly used in the art. The stains may include nuclear stains. The stains may include fluorescent stains including but not limited to Alexa Fluor 405, Alexa Fluor 700, APC-Cy7, DAPI, DRAQ5, ethidium iodide, FITC, Hoechst stain, Pacific Orange, phycoerythrin, and propidium iodide. The cells may be tagged with one or more antibodies recognizing surface molecules (e.g. CD 3, CD 10, CD 11a, CD 12, CD 13, CD 14, CD 17, CD 22, CD 29, CD 31, CD 33, CD 34, CD 35, CD 36, CD 38, CD 43, CD 44, CD 45, CD 47, CD 49, CD 50, CD 52, CD 53, CD 55, CD 59, CD 63, CD 66, CD 69, CD 71, CD 81, CD 84, CD 87, CD 88, CD 90, CD 102, CD 114, CD 116, CD 117, CD 123, CD 124, CD 127, CD 131, CD 135, CD 147, or CD 166).

This pre-stain may allow more even staining/tagging than is possible after the cells are in a monolayer.

The pre-stain may be applied on fixed or unfixed cells. Pre-staining without fixing the cells may result in better morphology than might be observed in cells which have been subjected to a fixation step.

Use of specific chemistries that maintain the cell morphology while the cells are drying may improve morphology and subsequent analysis. The stabilizers may serve to reduce background and nonspecific binding during antibody and/or in situ hybridization staining or other treatments. Additives that stabilize the cell membrane and proteins maintain cellular morphology during the monolayering and drying processes may be added.

In one embodiment, cell attachment during monolayer attachment may be facilitated by a treatment (e.g. addition of dextran(s)).

In another embodiment, cell clumping may be reduced during the monolayering process (e.g. by addition of albumin(s) and/or detergent(s)).

In another embodiment, the optical properties of the monolayer may be improved by the treatment (e.g. an added sugar may dry as glass).

In another embodiment, clotting and/or phosphatase activity may be inhibited by the treatment (e.g. addition of fluoride(s)).

After cells have been deposited onto the substrate, they can be subject to further analysis. In some embodiments, cells are analyzed using a fetal marker to differentiate fetal from maternal cells. The marker may recognize a protein expressed in the fetal cells.

In another embodiment, standard antibody staining for fetal hemoglobin and/or embryonic hemoglobin (e.g. zeta, epsilon, or gamma hemoglobin) may be performed on the slides or on specific nucleated red blood cells (nRBCs) located on slides using automated cell identification algorithms (e.g. as described in U.S. patent application 13/046,543, filed Mar. 11, 2011). Although adult RBC's don't generally express embryonic or fetal hemoglobins, an atypical condition in the mother such as anemia or cancer may cause maternal RBCs to stain positively for zeta, epsilon and/or gamma hemoglobin. In this case, alternative markers for identifying fetal cells are needed.

Other fetal markers may be used in addition to, or instead of, fetal hemoglobin and embryonic hemoglobin markers. In some embodiments, the other fetal markers are also antibodies that identify proteins selectively expressed in the fetal cells. Antibodies against any of the proteins listed in U.S. Patent Publications 20040185495 and 20060040305 and specifically expressed in fetal cells may be used as markers.

In another embodiment, pyruvate kinase may be detected. Pyruvate kinase M2 (PKM2) is expressed during embryonic and fetal development. The pyruvate kinase M2 isoform is an alternatively spliced variant of PKM1, the adult form. This glycolytic enzyme produces and regulates the amount of cellular 2,3-DPG, which is essential to the oxygen response of embryonic, fetal, and adult hemoglobin. The 2,3-DPG regulatory activity of PKM2 is different from PKM1. In one embodiment, pyruvate kinase M2 is detected using an antibody.

In other embodiments, detection of RNA by in situ hybridization may be used to distinguish fetal and adult cells. Fluorescence detection of RNA (FISH) may be used.

In another embodiment, a nucleic acid corresponding to a messenger RNA may be used as a probe for performing RNA in situ hybridization on the slide or on specific cells on the slide to distinguish fetal from adult cells (see e.g. U.S. Patent Publications 20060040305 and 20040185495).

In another embodiment, a nucleic acid that recognizes a non-coding antisense RNA from an imprinted transcriptional unit (ITU) pair may be used as a probe for performing RNA in situ hybridization on the slide or on specific cells on the slide to identify a fetal cell. The RNA may be spliced or unspliced. XIST and TSIX are DNA sequences found on the X chromosome that produce antisense ncRNA transcripts. Probes recognizing XIST and TSIX RNAs can be used to identify fetal cells (see e.g. U.S. patent application 13/046,543, filed Mar. 11, 2011).

In another embodiment, a probe that corresponds to a member of an ITU class that produces antisense, non-micro RNAs can be used as a fetal marker to differentiate fetal and maternal cells from each other. The ITU genes may be on the sex chromosomes or may be autosomal. The list includes AIR, an antisense RNA to the IGF2r gene; MESTIT1, an antisense RNA to MEST; COPG2IT1, an antisense RNA to COPG2; IGF2AS, an antisense RNA to IGF2; KCNQ1OT1, an antisense RNA to KCNQ1; WT1AS, an antisense RNA to WT1; an antisense RNA to MKRN3; an antisense RNA to UBE3A; and GNAS, an antisense RNA to SANG.

In another embodiment, a nucleic acid that recognizes a non-coding, micro RNA may be used as a probe for performing RNA in situ hybridization on the slide or on specific cells on the slide in order to distinguish fetal from adult cells. The gene may be imprinted. In one case, a nucleic acid probe was used to detect a micro RNA (H19, see US 2006/0040305).

Genetic fetal/maternal differentiation of nRBC's collected from maternal peripheral blood can be performed on other rare cells. The standard DNA FISH procedure identifies the Y chromosome of an nRBC if the fetus is male. The TSIX RNA FISH procedure identifies RNA from the fetal X chromosome of an nRBC if the fetus is female. These assignations can be confirmed by applying the same genetic testing procedures to the nuclei of other fetal cells such as fetal white blood cells (WBC), stem cells and placental cells such as trophoblasts found in the maternal peripheral blood.

### EXAMPLES

### Example 1

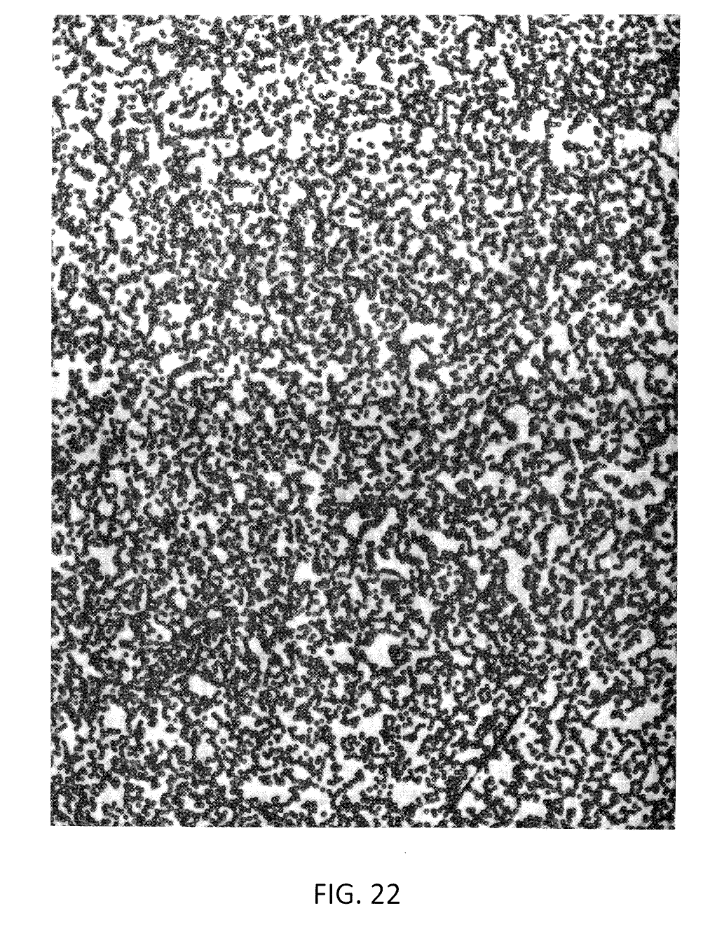

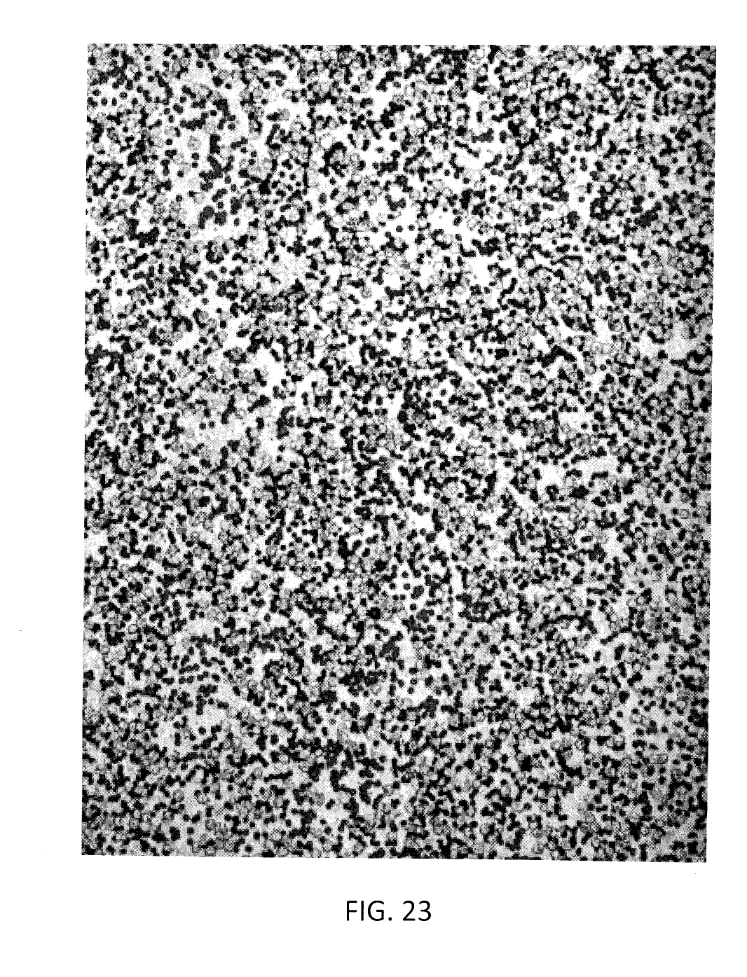

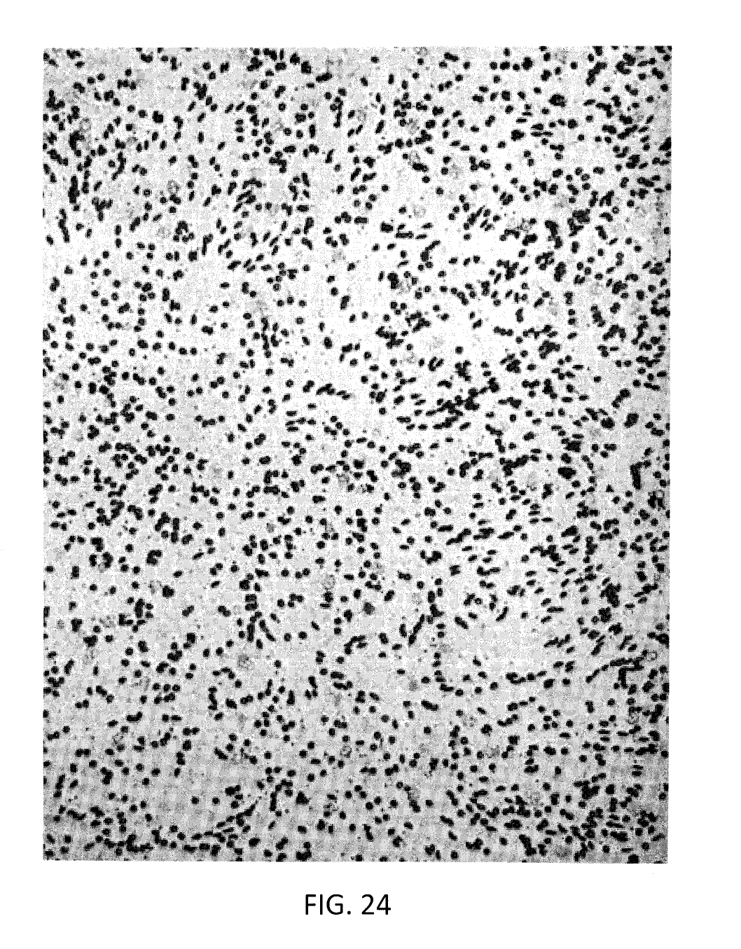

FIG. 19 shows a schematic layer of predominantly red blood cells from a whole blood smear where the vast majority of cells in the sample are red blood cells 500. This image shows a typical high density smear of red blood cells imaged with 420 nm transmitted light to highlight the cells using hemoglobin absorption. The smear parameters were 25 mm/sec smear speed, smooth edge glass smear head, styrene flexure, and 30 degree smear head angle. FIG. 22 is a photograph that shows a portion of a representative smear of the original results.

### Example 2

FIG. 20 shows a layer of cells enriched for cells of interest and smeared using the same parameters as described above for FIG. 19, but with a higher smear blade/substrate angle. Many white blood cells 504 are detected among the red blood cells 502. FIG. 23 is a photograph that shows a portion of a representative smear of the original results.

### Example 3

FIG. 21 shows a layer of cells enriched for cells of interest and smeared using the same parameters as described above for FIGS. 19 and 20, except that a medium angle smear (25 degrees) was used. White blood cells 512 are detected among red blood cells 510. Note the reduced density of the smear showing the ability to control smear density by head angle. FIG. 24 is a photograph that shows a portion of a representative smear of the original results.

### REFERENCES

Comparison of the classical manual pushed wedge films, with an improved automated method for making blood smears; L. Benattar and G. Flandrin; 1999; Hematol Cell Ther 41: 211-215

Automated detection of working area of peripheral blood smears using mathematical morphology; Jesus Angulo and Georges Flandrin; 2003; Analytical Cellular Pathology 25: 37-49

Automatic working area classification in peripheral blood smears without cell central zone extraction.; Xiong W, Lim J H, Ong S H, Tung N N, Liu J, Racoceanu D, Tan K, Chong A, Foong K.; Conf Proc IEEE Eng Med Biol Soc. 2008; 2008:4074-7 http ://www.uvm.edu/˜schall/pdfs/techniques/bloodsmears.pdf).

Automatic Working Area Classification in Peripheral Blood Smears Using Spatial Distribution Features Across Scales; W. Xiong, S. H. Ong, J. H. Lim, N.N. Tung, J. Liu, D. Racoceanu, K. Tan, A. Chong, K. Foong; 2008; 19th International Conference on Pattern Recognition, ICPR 2008

Slide Preparation with Sysmex SP-Series; http://www.sysmex-europe.com/files/articles/Xtra_SP1000i.pdf; Sysmex Xtra Online, Volume No. 1, January 2007

http://www.beckmancoulter.com/literature/ClinDiag/BR-13034A.pdf.

James N. George; 1970; Adhesion of Human Erythrocytes to Glass: The Nature of the Interaction and the Effect of Serum and Plasma; J. Cell Physiology 77: 51-60

James N. George; 1972; Fibrinogen Inhibits Red Cell Adhesion to Glass; J. Cell Physiology 79: 457-462

Annette Trommler, David Gingell, H. Wolf; 1985; Red Blood Cells Experience Electrostatic Repulsion but make Molecular Adhesions with Glass; Biophysical Journal 48: 835-841

Z. Xia, H. L. Goldsmith, T. G. M. van de Ven; 1993; Kinetics of Specific and Nonspecific Adhesion of Red Blood Cells on Glass; Biophysical Journal 65: 1073-1083

N. Mohandas, R. M. Hochmuth, E. E. Spaeth; 1974; Adhesion of Red Cells to Foreign Surfaces in the Presence of Flow; Journal of Biomedical Material Research 8: 119-136

Bjorn Neu, Herbert J. Meiselman; 2006; Depletion Interactions in Polymer Solutions Promote Red Blood Cell Adhesion to Albumin-coated Surfaces; Biochim Biophys Acta. 1760(12): 1772-1779

H. Wolf, D. Gingell; 1983; Conformational Response of the Glycocalyx to Ionic Strength and Interaction with Modified Glass Surfaces: Study of Live Red Cells by Interferometry; Journal of Cell Science 63: 101-112

Erwin A. Vogler; 1989; A Thermodynamic Model of Short-Term Cell Adhesion in Vitro; Colloids and Surfaces 42: 233-254

K. D. Tachev, J. K. Angarska, K. D. Danov, P. A. Kralchevsky; 1999; Erythrocyte Attachment to Substrates: Determination of Membrane Tension and Adhesion Energy; Colloids and Surfaces B: Biointerfaces 19: 61-80

Mukta Singh-Zocchi, Anita Andreasen, Giovanni Zocchi; 1999; Osmotic Pressure Contribution of Albumin to Colloidal Interactions; Proceedings of the National Academy of Sciences, USA 96: 6711-6715

H. K. Yang, Y. D. Chung, S. W. Whangbo, Y. S. Lee, I. W. Lyo, C. N. Whang, S. J. Lee, G. Kim; 1999; Effects of Chemical Etching with Sulfuric Acid on Glass Surface; Journal of Vacuum Science Technology A 18(2); 401-404

H. K. Yang, Y. D. Chung, S. W. Whangbo, T. G. Kim, C. N. Whang, S. J. Lee, S. Lee; 2000; Effects of Chemical Etching with Nitric Acid on Glass Surface; Journal of Vacuum Science Technology A 19(1); 267-274

J. J. Cras, C. A. Rowe-Taitt, D. A. Nivens, F. S. Lighter; 1999; Comparison of Chemical Cleaning Methods of Glass in Preparation for Silanization; Biosensors and Biolelectronics 14; 683-688

US patent publications: US 2002/0045196, US 2003/0013123, US 2003/0165852, US 2004/0185495, US 2006/0040305, US 2010/00035246.

PCT publication: WO/2006/018849

As for additional details pertinent to the present invention, materials and manufacturing techniques may be employed as within the level of those with skill in the relevant art. The same may hold true with respect to method-based aspects of the invention in terms of additional acts commonly or logically employed. Also, it is contemplated that any optional feature of the inventive variations described may be set forth and claimed independently, or in combination with any one or more of the features described herein. Likewise, reference to a singular item, includes the possibility that there are plural of the same items present. More specifically, as used herein and in the appended claims, the singular forms “a,” “and,” “said,” and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. Unless defined otherwise herein, all technical and scientific terms used herein have the same meaning as commonly understood by one of ordinary skill in the art to which this invention belongs. The breadth of the present invention is not to be limited by the subject specification, but rather only by the plain meaning of the claim terms employed.

1. A method of creating a layer of cells on a surface comprising:
engaging a smear tool against the surface with an engagement force;
flexing a portion of the smear tool to change an orientation of the smear tool with respect to the surface;
moving the smear tool along the surface through a sample comprising cells suspended in a liquid; and
adhering the sample to the surface to thereby create a layer of cells.

2. The method of claim 1 wherein the smear tool comprises a forward edge, the engaging step comprising changing a relative angle between the forward edge and the surface.

3. The method of claim 1 further comprising, prior to the moving step, dispensing the sample onto the surface in a sample pattern that extends at least three times further in a first direction than in a direction perpendicular to the first direction.

4. The method of claim 3 wherein the sample pattern comprises two separate sample portions.

5. The method of claim 3 wherein the sample pattern comprises a continuous shape.

6. The method of claim 1 further comprising monitoring a parameter of the sample.

7. The method of claim 6 wherein monitoring comprises measuring light transmittance through at least a portion of the sample.

8. The method of claim 7 wherein the measuring comprises measuring light transmittance through the layer of cells.

9. The method of claim 6 wherein the moving step comprises controlling movement of the smear tool using closed loop feedback based on the parameter.

10. The method of claim 1 wherein the smear tool comprises a forward edge, the method further comprising changing a distance between the forward edge and the surface during the moving step.

11. The method of claim 1 further comprising, prior to the moving step, dispensing the sample onto the surface and thereafter mixing at least a portion of the sample.

12. The method of claim 11 further comprising mixing at least a portion of the sample prior to the moving step.

13. The method of claim 12 further comprising engaging the smear tool with the sample prior to the mixing step.

14. The method of claim 13 wherein engaging comprises moving the smear tool in a first direction along the surface to engage the smear tool with the sample, the mixing step comprising moving the smear tool in a direction other than the first direction after engaging the smear tool with the sample.

15. The method of claim 12 wherein mixing comprises oscillating the smear tool.

16. The method of claim 15 wherein oscillating comprises oscillating the smear tool at a frequency between about 1 Hz to about 100 Hz.

17. The method of claim 12 wherein mixing comprises moving the smear tool in at least two directions with respect to the surface.

18. The method of claim 12 wherein mixing comprises changing a distance between the smear tool and the surface.

19. The method of claim 11 further comprising mixing at least a portion of the sample during the moving step.

20. The method of claim 19 wherein moving comprises moving the smear tool in a first direction, the mixing step comprising moving the smear tool in a direction other than the first direction.

21. The method of claim 19 wherein mixing comprises oscillating the smear tool.

22. The method of claim 21 wherein oscillating comprises oscillating the smear tool at a frequency between about 1 Hz to about 100 Hz.

23. The method of claim 19 wherein mixing comprises moving the smear tool in at least two directions with respect to the surface.

24. The method of claim 19 wherein mixing comprises changing a distance between the smear tool and the surface.

25. The method of claim 1 wherein moving comprises varying a relative speed between the smear tool and the surface.

26. The method of claim 1 further comprising accelerating drying of the monolayer after the adhering step.

27. The method of claim 1 wherein the adhering step comprises adhering the sample in a smear at least about 50 mm long.

28. The method of claim 1 wherein the adhering step comprises adhering the sample in a smear having an area of at least 16,000 mm².

29. The method of claim 1 wherein the adhering step comprises adhering the sample in a smear having an area of at least 1000 mm².

30. The method of claim 1 wherein the adhering step comprises adhering the sample in a smear having no more than a monolayer of cells over most of the smear.

31. The method of claim 30 wherein the adhering step further comprises adhering the sample in a smear having a cell density equal to or greater than 80%.

32. The method of claim 1 wherein the sample is a blood sample, the method further comprising, prior to the moving step:
determining a parameter of the sample selected from a group consisting of hematocrit, white blood cell count, platelet count, sample storage container oxygen level, and sample storage container fill percentage; and
adjusting movement of the smear tool based on the determined parameter.

33. A method of creating a layer of cells on a surface comprising:
dispensing on the surface a sample comprising cells suspended in a liquid;
moving a smear tool along the surface through the sample;
mixing at least a portion of the sample; and
adhering the sample to the surface to thereby create a layer of cells.

34. The method of claim 33 wherein the dispensing step comprises dispensing the sample onto the surface in a sample pattern that extends at least three times further in a first direction than in a direction perpendicular to the first direction.

35. The method of claim 34 wherein the sample pattern comprises two separate sample portions.

36. The method of claim 34 wherein the sample pattern comprises a continuous shape.

37. The method of claim 33 further comprising monitoring a parameter of the sample.

38. The method of claim 37 wherein monitoring comprises measuring light transmittance through at least a portion of the sample.

39. The method of claim 38 wherein the measuring comprises measuring light transmittance through the layer of cells.

40. The method of claim 37 wherein the moving step comprises controlling movement of the smear tool using closed loop feedback based on the parameter.

41. The method of claim 33 further comprising engaging the smear tool with the sample prior to the mixing step.

42. The method of claim 41 wherein engaging comprises moving the smear tool in a first direction along the surface to engage the smear tool with the sample, the mixing step comprising moving the smear tool in a direction other than the first direction after engaging the smear tool with the sample.

43. The method of claim 41 wherein mixing comprises oscillating the smear tool.

44. The method of claim 43 wherein oscillating comprises oscillating the smear tool at a frequency between about 1 Hz to about 100 Hz.

45. The method of claim 41 wherein mixing comprises moving the smear tool in at least two directions with respect to the surface.

46. The method of claim 41 wherein mixing comprises changing a distance between the smear tool and the surface.

47. The method of claim 33 wherein mixing comprises mixing at least a portion of the sample during the moving step.

48. The method of claim 47 wherein moving comprises moving the smear tool in a first direction, the mixing step comprising moving the smear tool in a direction other than the first direction.

49. The method of claim 47 wherein mixing comprises oscillating the smear tool.

50. The method of claim 49 wherein oscillating comprises oscillating the smear tool at a frequency between about 1 Hz to about 100 Hz.

51. The method of claim 47 wherein mixing comprises moving the smear tool in at least two directions with respect to the surface.

52. The method of claim 47 wherein mixing comprises changing a distance between the smear tool and the surface.

53. The method of claim 33 wherein moving comprises varying a relative speed between the smear tool and the surface.

54. The method of claim 33 further comprising accelerating drying of the monolayer after the adhering step.

55. The method of claim 33 wherein the adhering step comprises adhering the sample in a smear at least about 50 mm long.

56. The method of claim 33 wherein the adhering step comprises adhering the sample in a smear having an area of at least 16,000 mm².

57. The method of claim 33 wherein the adhering step comprises adhering the sample in a smear having an area of at least 1000 mm².

58. The method of claim 33 wherein the adhering step comprises adhering the sample in a smear having no more than a monolayer of cells over most of the smear.

59. The method of claim 58 wherein the adhering step further comprises adhering the sample in a smear having a cell density equal to or greater than 80%.

60. The method of claim 33 wherein the sample is a blood sample, the method further comprising, prior to the moving step:
determining a parameter of the sample selected from a group consisting of hematocrit, white blood cell count, platelet count, sample storage container oxygen level, and sample storage container fill percentage; and
adjusting movement of the smear tool based on the determined parameter.

61. The method of claim 33 wherein the smear tool comprises a forward edge, the method further comprising changing a distance between the forward edge and the surface during the moving step.

62. An apparatus for creating a cell layer on a surface from a sample comprising cells suspended in a liquid, the apparatus comprising:
a surface;
a smear blade; and
a blade motion mechanism comprising a motor, a smear blade linkage and a controller configured to move the smear blade with respect to the surface along an X axis and along a Y axis perpendicular to the X axis to adhere the cells in a layer on the surface.

63. The apparatus of claim 62 further comprising a sample dispenser adapted to dispense the sample onto the surface in a sample pattern that extends at least three times further in the X direction than in the Y direction.

64. The apparatus of claim 63 wherein the sample pattern comprises two separate sample portions.

65. The apparatus of claim 63 wherein sample pattern comprises a continuous shape.

66. The apparatus of claim 62 further comprising a sample monitor adapted to monitor a parameter of the sample.

67. The apparatus of claim 66 wherein the monitor comprises a light transmittance monitor configured to monitor light transmittance through at least a portion of the sample.

68. The apparatus of claim 67 wherein the light transmittance monitor is configured to monitor light transmittance through the cell layer on the surface.

69. The apparatus of claim 66 wherein the monitor is configured to communicate the monitored parameter to the controller and the controller is further configured to control movement of the smear blade using closed loop feedback based on the parameter.

70. The apparatus of claim 62 wherein the blade motion mechanism is adapted to apply a force to the surface with the smear blade.

71. The apparatus of claim 70 wherein the smear blade is adapted to flex when it applies a force to the surface.

72. The apparatus of claim 70 wherein the smear blade comprises a forward edge, the blade motion mechanism being further adapted to permit the forward edge to change an angle with respect to the surface as the smear blade applies the force to the surface.

73. The apparatus of claim 70 wherein the linkage is adapted to flex when the smear blade applies a force to the surface.

74. The apparatus of claim 62 wherein the smear blade comprises a forward edge comprising a non-linear portion.

75. The apparatus of claim 74 wherein the non-linear portion of the forward edge comprises notches.

76. The apparatus of claim 74 wherein the non-linear portion of the forward edge comprises a rough surface.

77. The apparatus of claim 74 wherein the non-linear portion of the forward edge comprises a curve.

78. The apparatus of claim 62 wherein at least a portion of the smear blade is less hydrophilic than the surface.

79. The apparatus of claim 62 wherein the blade motion mechanism is adapted to mix at least a portion of the sample as the smear blade moves with respect to the surface.

80. The apparatus of claim 62 wherein the blade motion mechanism is adapted to move the smear blade toward or away from the surface as it moves in the X direction or the Y direction.

81. The apparatus of claim 62 further comprising a sample dryer.

82. The apparatus of claim 81 wherein the sample dryer is adapted to move warm gas over the sample.

83. An apparatus for creating a cell layer on a surface from a sample comprising cells suspended in a liquid, the apparatus comprising:
a surface;
a smear blade; and
a blade motion mechanism comprising a motor, a smear blade linkage and a controller configured to engage the smear blade against the surface with an engagement force and to move the smear blade with respect to the surface to adhere the cells in a layer on the surface, at least one of the smear blade and the linkage being adapted to flex to change an orientation of the smear blade with respect to the surface.

84. The apparatus of claim 83 further comprising a sample dispenser adapted to dispense the sample onto the surface in a sample pattern that extends at least three times further along an X axis than along a Y axis perpendicular to the X axis.

85. The apparatus of claim 84 wherein the sample pattern comprises two separate sample portions.

86. The apparatus of claim 84 wherein sample pattern comprises a continuous shape.

87. The apparatus of claim 83 further comprising a sample monitor adapted to monitor a parameter of the sample.

88. The apparatus of claim 87 wherein the monitor comprises a light transmittance monitor configured to monitor light transmittance through at least a portion of the sample.

89. The apparatus of claim 88 wherein the light transmittance monitor is configured to monitor light transmittance through the cell layer on the surface.

90. The apparatus of claim 87 wherein the monitor is configured to communicate the monitored parameter to the controller and the controller is further configured to control movement of the smear blade using closed loop feedback based on the parameter.

91. The apparatus of claim 83 wherein the smear blade comprises a forward edge comprising a non-linear portion.

92. The apparatus of claim 91 wherein the non-linear portion of the forward edge comprises notches.

93. The apparatus of claim 91 wherein the non-linear portion of the forward edge comprises a rough surface.

94. The apparatus of claim 91 wherein the non-linear portion of the forward edge comprises a curve.

95. The apparatus of claim 83 wherein at least a portion of the smear blade is less hydrophilic than the surface.

96. The apparatus of claim 83 wherein the blade motion mechanism is adapted to mix at least a portion of the sample as the smear blade moves with respect to the surface.

97. The apparatus of claim 83 wherein the blade motion mechanism is adapted to move the smear blade toward or away from the surface as it moves in the X direction or the Y direction.

98. The apparatus of claim 83 further comprising a sample dryer.

99. The apparatus of claim 98 wherein the sample dryer is adapted to move warm gas over the sample.

100. (canceled)

101. (canceled)

102. (canceled)

103. (canceled)
